(19) United States
(12) Patent Application Publication
(10) Pub. No.: US 2017/0042361 A1
(43) Pub. Date: Feb. 16, 2017

(54) DUTCH COFFEE CAPSULE

(71) Applicant: KIV CO., LTD, Yongin-si Gyeonggi-do (KR)

(72) Inventor: Hyun Dae KIM, Gyeonggi-d (KR)

(21) Appl. No.: 15/304,799

(22) PCT Filed: Apr. 13, 2015
(86) PCT No.: PCT/KR2015/003666

§ 371 Date: Oct. 17, 2016

(30) Foreign Application Priority Data
Apr. 18, 2014 (KR) 10-2014-0046473

(51) Int. Cl. A47J 31/02; A47J 31/44; A47J 31/06

(52) U.S. Cl. CPC A47J 31/02; A47J 31/06; A47J 31/4403

(57) ABSTRACT

According to the present invention, provided is a Dutch coffee capsule comprising: a cylindrical cylinder (10) for accommodating coffee grains (G); a coffee extraction part (20) which is coupled to one end of the cylinder (10) such that a coffee extract flows out; a water inlet part (30) which is coupled to the other end of the cylinder (10) such that water enters therethrough; and a compressive spray part (40) which applies a compressive force to the accommodated coffee grains (G) by coming into close contact with an inner wall of the cylinder (10), and which enables a uniform amount of water to permeate therethrough.

### TECHNICAL FIELD

The present invention relates to a disposable Dutch coffee capsule, and more particularly, to a Dutch coffee capsule which is able to enhance the flavor of a coffee extract which spreads and flows down based on a compressive density with respect to the coffee grains accommodated in the capsule, and a Dutch coffee can be easily used.

### BACKGROUND

The method for extracting a coffee, in general, is implemented in such a way that the beans of coffee are crushed and are filled in an inverted triangle and conical filter, and hot water is poured over the crushed beans at a room temperature. When the coffee powder is placed in the filter using an extractor called a coffee drip, and hot water is poured over the coffee powder, and a cup is pushed under the filter of the extractor. When the extractor is activated in this state, the water will be heated and gather on the coffee, and the coffee is extracted into the form of a coffee extract, and the coffee extract will drip down with the aid of gravity.

In this coffee extraction method, since the coffee extract is quickly extracted using the heated water, it may be hard to obtain the natural flavor of the coffee.

For this reason, the Dutch coffee extraction method is gaining popularity among coffee lovers, wherein the coffee extract is extracted for a long time at a room temperature so as to obtain the unique flavor of the coffee extract when extracting the coffee. In recent years, this method is gaining more interests and responses.

When extracting the Dutch coffee, since the coffee extract is extracted in such a way that water drips drop by drop into a coffee container filled with the coffee powder using a room temperature water or a cold water, a lot of time and technology, and a unique tool, etc. are necessary. It is actually hard for an ordinary person to experience such a Dutch coffee.

In order to resolve the aforementioned problem, the Korean patent number 10-1349074 describes a Dutch coffee extractor which is formed of a sealed water tank having a mouth, a first packing stopper which is assembled to the mouth and is configured to seal the water tank, a drip port one end of which is inserted and engaged integral to the first packing stopper, and a dripping amount adjustment valve which is provided in the middle of the drip port and is able to accurately adjust the amount of dripping water which drops from the water tank to the bean tank.

In this conventional technology, the dripping water drops can be accurately adjusted; however it needs a complicated configuration to implement such a purpose, and it is not portable.

In terms of the extraction of the Dutch coffee, it is hard to overcome the extraction time limit, and since the dripping water drops in the same place, the uniform extraction of the coffee extract with respect to the coffee grains is actually impossible, and only a uniform coffee flavor can be provided.

For this reason, it urgently needs to develop a new Dutch coffee which is able to resolve the aforementioned problems.

### SUMMARY OF THE INVENTION

Accordingly, the present invention are directed to providing a Dutch coffee capsule which is able to reduce the extraction time of a Dutch coffee and provide a uniform extraction of a coffee extract with respect to the whole coffee grains is available.

In addition, the present invention are directed to providing a Dutch coffee capsule which is variable the density of the coffee grains based on a user's favorite.

In addition, the present invention are directed to providing a Dutch coffee capsule that a user can easily carry with him when it needs to drink Dutch coffee.

### Technical Solution

According to the present invention, provided is a Dutch coffee capsule, which may include, but is not limited to, a cylindrical cylinder 10 for accommodating coffee grains (G); a coffee extraction part 20 which is coupled to one end of the cylinder 10 such that flows out; and a compressive spray part 40 which is provided with a plurality of small holes 42 and a piston block 44 which applies a compressive force to the accommodated coffee grains (G) by coming into close contact with an inner wall of the cylinder 10, and which enables a uniform amount to water to permeate therethrough.

Here, the coffee extraction part 20 may include an engaging finishing part 22 which is engaged to an end of the cylinder 10; a filter 24 which is seated on the upper side of the engaging finishing part 22 and is able to prevent the discharge of the coffee grains (G); and a filter seating part 26 which fixedly contacts close to the lower end of the inner side of the cylinder 10 so as to fixedly seat the filter 24 with respect to the engaging finishing part 22.

Moreover, the filter seating part 26 may include a first outer circumferential surface 26a having an outer diameter corresponding to the inner diameter of the cylinder 10; a second outer circumferential surface 26b having an outer diameter corresponding to the outer diameter of the cylinder 10 and configured to be seated at an end of the cylinder 10; and a rib 26c which is provided at an inner, lower side so as to provide a seating force to the filter 24.

In addition, in terms of the engagement between the coffee extraction part 20 and the cylinder 10, the engaging finishing part 22 is engaged with respect to an end of the cylinder 10 in a state where the shoulder of the second outer circumferential surface 26b of the filter seating part 26 has been seated at an end of the cylinder 10, and then the filter 24 has positioned at the lower surface of the rib 26c of the filter seating part 26.

Furthermore, the outer side of the piston block 44 has a friction coefficient with respect to the inner side of the cylinder 10 so as to prevent the degradation of the compressive density of the compressed coffee grains (G).

Moreover, the size of each small hole 42 of the compressive spray part 40 is large enough to allow the water to slowly and evenly permeate into the coffee grain accommodation part 12 while withstanding the gravity with the aid of the surface tension of the water falling down into the water accommodation part 14 of the upper surface of the piston block 44.

In addition, the water inlet part 30 may include an engaging block 32 which is engaged to the other end of the cylinder 10 and has an opening part 32a in the center thereof, and a sealing sheet 34 configured to seal the opening 32a.

Furthermore, an engaging finishing part 22′ is formed integral with the cylinder 10, and in a state where the filter 24 has been seated on the upper surface of the inner side of the engaging finishing part 22′ formed integral with the cylinder 10, the filter seating part 26 is inserted into the inner side of the cylinder 10, and the filter 24 is fixedly seated.

Moreover, the engaging finishing part 22′ is formed integral with the cylinder 10, and in a state where the filter 24 has been seated on the upper surface of the inner side of the engaging finishing part 22′ formed integral with the cylinder 10, the filter seating part 26 is inserted into the inner side of the cylinder 10, and the filter 24 is fixedly seated.

### Advantageous Effects

In the present invention, the extraction time of a Dutch coffee can be reduced by a predetermined time, and the flavor of coffee can be enhanced with respect to the same amount and time through the uniform extraction of a coffee extract with respect to the whole coffee grains. Moreover, the density of the coffee grains can be variable based on a user's preference, and the densely compacted coffee grains can be always maintained even when the user carries it with him, which makes it possible to provide a constant flavor, and the user can easily carry it with him.

### BRIEF DESCRIPTION OF THE DRAWINGS

FIG. 1 is a perspective view illustrating a Dutch coffee capsule according to a preferred exemplary embodiment of the present invention.

FIG. 2 is a disassembled perspective view illustrating a Dutch coffee capsule according to a preferred exemplary embodiment of the present invention.

FIG. 3 is a cross-sectional view for describing a process for variable density of the coffee grains in a Dutch coffee capsule according to a preferred exemplary embodiment of the present invention.

FIG. 4 is a cross-sectional view taken along the arrow AA in FIG. 1.

FIG. 5 is a cross-sectional view illustrating a use state of a Dutch coffee capsule according to a preferred exemplary embodiment of the present invention.

FIG. 6 is a cross-sectional view illustrating a Dutch coffee capsule according to a preferably modified example of the present invention.

FIG. 7 is a cross-sectional view illustrating a Dutch coffee capsule according to a preferably another modified example of the present invention.

FIG. 8 is a cross-sectional view illustrating a use state of a Dutch coffee capsule according to a preferably further another modified example of the present invention.

### BEST MODES FOR CARRYING OUT THE INVENTION

According to the present invention, provided is a Dutch coffee capsule, which may include, but is not limited to, a cylindrical cylinder 10 configured to accommodate coffee grains (G); a coffee extraction part 20 which is coupled to one end of the cylinder 10 such that flows out; and a compressive spray part 40 which is provided with a plurality of small holes 42 and a piston block 44 which applies a compressive force to the accommodated coffee grains (G) by coming into close contact with an inner wall of the cylinder 10, and which enables a uniform amount to water to permeate therethrough.

### MODES FOR CARRYING OUT THE INVENTION

The Dutch coffee capsule according to a preferred exemplary embodiment of the present invention will be described with reference to the accompanying drawings.

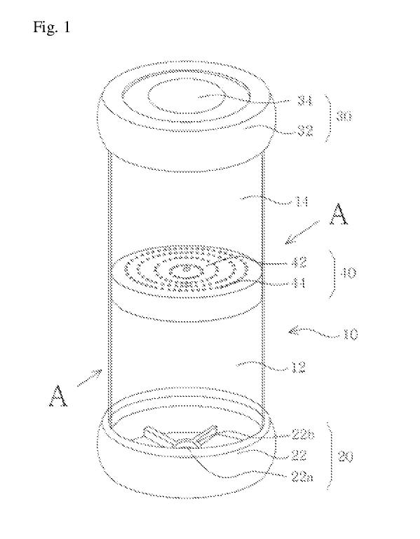

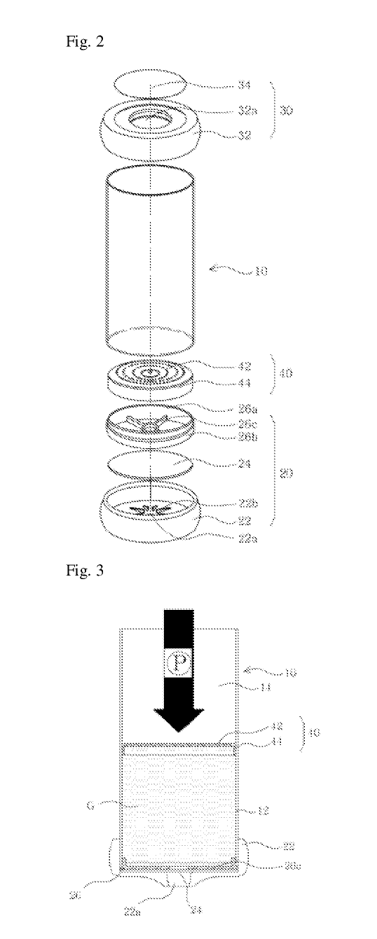

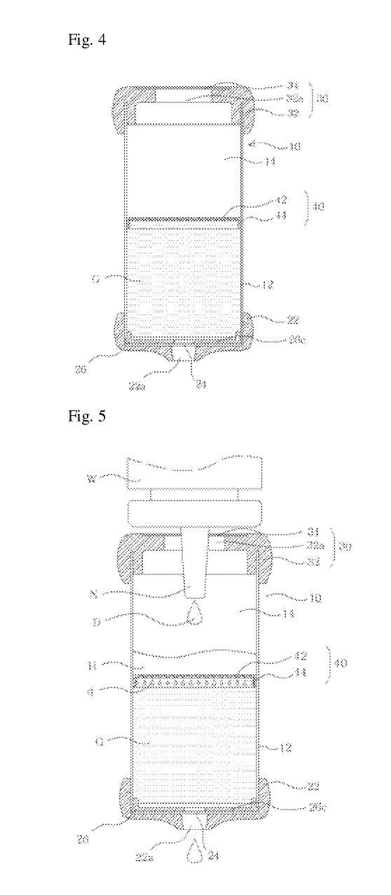

FIG. 1 is a perspective view illustrating a Dutch coffee capsule according to a preferred exemplary embodiment of the present invention. FIG. 2 is a disassembled perspective view illustrating a Dutch coffee capsule according to a preferred exemplary embodiment of the present invention. FIG. 3 is a cross-sectional view for describing a process for selectively determining the compactness between the coffee grains in a Dutch coffee capsule according to a preferred exemplary embodiment of the present invention. FIG. 4 is a cross-sectional view taken along the arrow AA in FIG. 1.

Referring to FIGS. 1 to 4, the Dutch coffee capsule according to a preferred exemplary embodiment of the present invention may include, but is not limited to, a cylindrical cylinder 10 configured to accommodate coffee grains (G), a coffee extraction part 20 which is engaged to an end of the cylinder 10 and is configured to extract a coffee extract, a water inlet part 30 which is engaged to the other end of the cylinder 10, wherein water flows into water inlet part 30, and a compressive spray part 40 which is able to supply a compressive force with respect to the coffee grains (G) which contact close to the inner wall of the cylinder, thus carrying out a water permeation.

The cylinder 10 is preferably made of a cylindrical synthetic resin material both ends of which are open. The cylinder 10 is formed of a water accommodation part 14 and a coffee grain accommodation part 12 which are partitioned by the compressive spray part 40.

Meanwhile, it is preferred that both ends of the outer side of the cylinder 10, the inner side of the coffee extraction part 20 and the inner side of the water inlet part 30 are equipped with screw threads (not illustrated) in order for both ends of the cylinder 10 to be thread-engaged with respect to the coffee extraction part 20 and the water inlet part 30.

The coffee extraction part 20 may include an engaging finishing part 22 engaged to an end of the cylinder 10, a filter 24 which is seated on the top of the engaging finishing part 22 and is able to prevent any discharge of the coffee grains (G), and a filter seating part 26 which fixedly contacts close to the lower end of the inner side of the cylinder 10 so as to fixedly seat the filter 24 with respect to the engaging finishing part 22.

The engaging finishing part 22 is preferably provided with screw threads at its inner side so as to be thread-engaged to an end of the outer side of the cylinder 10. An extraction port 22a is provided in the center of the bottom for the coffee extract to flow out. Meanwhile, the outer circumferential surface of the extraction port 22a is preferably formed inclined with respect to the bottom surface of the engaging finishing part 22. The outer circumference surface of the extraction port 22a is preferably provided with a protrusion 22b for the sake of the seating of the filter 24.

The filter 24 is preferably made of a micro mesh filter in order prevent the leakage of the coffee grains (G) through the extraction port 22a.

The filter seating part 26 allows the filter 24 to be fixed tight at the bottom surface of the inner side of the engaging finishing part 22 for the filter 24 to be fixedly seated on the bottom surface of the inner side of the engaging finishing part 22. The filter seating part 26 may include a first outer circumferential surface 26a having an outer diameter corresponding to the inner diameter of the cylinder 10, a second outer circumferential surface 26b which has an outer diameter corresponding to the outer diameter of the cylinder 10 and is configured to be seated on an end of the cylinder 10, and a rib 26c formed at an inner, lower portion so as to provide, for example, a seating force to the filter 24.

When the coffee extraction part 20 and the cylinder 10 are engaged, the shoulder of the second outer circumferential surface 26b of the filter seating part 26 is seated on an end of the cylinder 10, and then the filter 24 positions at the lower surface of the rib 26c of the filter seating part 26. In this state, the engaging finishing part 22 is engaged to an end of the cylinder 10.

In a state where the coffee extraction 20 and the cylinder 10 have been engaged with each other, the coffee grains (G) can be accommodated at a predetermined height inside the cylinder 10.

The upper surface of the compressive spray part 40 is formed of a piston block 44 having a number of small hole 42. More specifically, since the compressive spray part 40 supplies a compressive force with respect to the coffee grain (G) in a state where the coffee grains (G) are accommodated in the cylinder 10, the density between the coffee grains (G) can be enhanced. In order to continuously maintain the formed density, the compressive spray part 40 is provided with a piston block 44 having an outer diameter corresponding to the inner diameter of the cylinder 10 and the small holes 42 which is formed on the upper surface of the piston block 44, thus allowing an even water permeation.

The outer side of the piston block 44 may be made of a material having a predetermined friction coefficient with respect to the inner side of the cylinder 10 so as to prevent the degradation of the compressive density between the compressed coffee grains (G).

The sizes of each small hole 42 of the compressive spray part 40 may be determined in such a way that water can evenly permeate into the coffee grain accommodation part 12 while withstanding the gravity with the aid of the surface tension of the water which falls down into the water accommodation part 14 on the upper surface of the piston block 44.

The water inlet part 30 may be formed of an engaging block 32 engaged to the other end of the cylinder 10 and having an opening part 32a in the center thereof, and a sealing sheet 34 which is able to seal the opening 32a.

The engaging block 32 is preferably provided with screw threads to be thread-engaged with the outer side of the other end of the cylinder 10. The sealing sheet 34 is preferably bonded, for example, using an adhesive with respect to the opening 32a.

Meanwhile, the sealing sheet 34 is preferably made of a thin film synthetic resin material for the sake of an easier insertion when inserting a nozzle (N) with respect to the nozzle (N) of a water supply part (W). The engaging block 32 and the sealing sheet 34 are preferably bonded together, for example, by a thermal bonding method.

Referring to FIG. 3, the Dutch coffee capsule according to the present invention may be configured in such a way that the shoulder of the second outer circumferential surface 26b of the filter seating part 26 is seated on an end of the cylinder 10, and then the filter 24 positions at the lower surface of the rib 26c of the filter seating part 26. In this state, the engaging finishing part 22 is engaged to an end of the cylinder 10, and then the coffee grains (G) are accommodated at a predetermined height inside the cylinder 10. Thereafter, the compressive spray part 40 may apply a compressive force (P) from the outside as indicated by the arrow, whereby the density between the coffee grains (G) can be enhanced. The enhanced density can be continuously maintained with the aid of the friction force between the outer side of the compressive spray part 40 and the inner side of the cylinder 10.

Thereafter, the water inlet part 30 is engaged to the other end of the cylinder 10, so the user can easily carry the Dutch coffee with him and can enjoy the natural flavor of the coffee by preventing any change in the compactness between the coffee grains (G) which might occur while carrying it.

FIG. 5 is a cross-sectional view illustrating a use state of the Dutch coffee capsule according to a preferred exemplary embodiment of the present invention.

As illustrated in FIG. 5, when the sealing sheet 34 of the water inlet part 30 is inserted with respect to the nozzle (N) of the water supply part (W), and the main body of the Dutch coffee capsule is hung (not illustrated), large size water drops (D) fall down from the nozzle (N) into the water accommodation part 14 of the cylinder 10 and are accommodated partially on the compressive spray part 40, and at the same time, the water accommodated in the water accommodation part 14 can evenly and slowly permeate into the coffee grains (G) of the coffee grain accommodation part 12 through the small holes 42 formed on the upper surface of the piston block 44, not quickly permeating into the coffee grain accommodation part 12, with the aid of the surface tension between the small holes 42 formed on the upper surface of the piston block 44 and the water. In the drawing, an unexplained code (d) represents water drops which permeate through the small hole 42, and (H) represents a state where the water drop (D) which has fallen into the water accommodation part 14, is temporarily accommodated on the upper surface of the compressive spray part 40 with the aid of the surface tension itself.

In the Dutch coffee capsule according to a preferred exemplary embodiment of the present invention, the small water drops (d) permeate with respect to the coffee grains (G) through the evenly distributed small holes 42 in order for water to permeate through all the portions with the aid of the surface tension of water, by which a rich flavor and taste of the coffee can be condensed and extracted, which may differ from the conventional wherein the water drops fall down from the nozzle into the coffee grains at the same position, and the coffee extract is extracted only through a partial portion of the accommodated coffee grains.

In the above-described exemplary embodiment, the coffee extraction part 20 has been described as being engaged separate from the cylinder 10. According to a preferably modified example of the present invention, the coffee extraction part 20 and the cylinder 10 may be formed integral with each other.

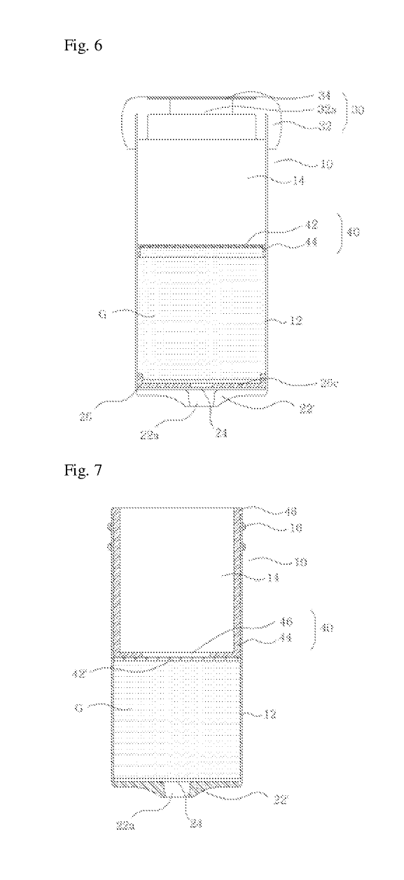

FIG. 6 is a cross-sectional view illustrating a Dutch coffee capsule according to a preferably modified example of the present invention.

In the preferably modified example of the present invention, the same configuration as the above embodiment will be assigned with the same reference numbers, and the descriptions thereon will be omitted.

Referring to FIG. 6, according to the preferably modified example of the present invention, an engaging finishing part 22′ may be formed integral with the cylinder 10. In a state where the filter 24 is seated on the upper surface at an inner side of the engaging finishing part 22′ formed integral with the cylinder 10, the filter seating part 26 may be inserted into the inner side of the cylinder 10, and the filter 24 may be fixedly seated. Thereafter, the coffee grains (G) are accommodated in the coffee grain accommodation part 12. The remaining configurations are same as in the previous embodiments.

In the modified example of the present invention, if the coffee grains (G) are accommodated in the coffee grain accommodation part 12 and are compressed by the compression spray part 40 in a state where the extraction port 22a has been supported by a support member (not illustrated), the filter seating part 26 may be removed.

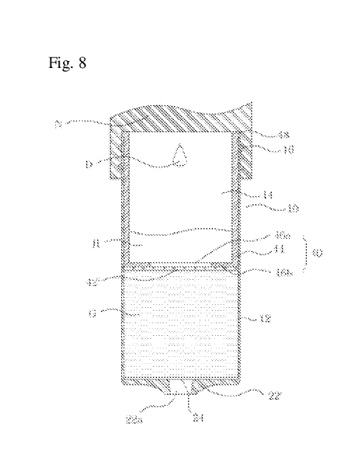

Meanwhile, in the modified example, the filter 24 is fixedly seated by the filter seating part 26, but as illustrated in FIGS. 7 and 8, according to the Dutch coffee capsule according to a preferably another modified example of the present invention, it can be seated with the aid of the pressure which is applied by the piston block 44 with respect to the coffee grains (G) in a state where the filter 24 has been seated at the upper surface of inner side the extraction port 22a.

Meanwhile, the piston block 44 of the compressive spray part 40 may slide at the inner side of the cylinder 10 and compress with respect to the coffee grains (G), wherein the piston surface which defines the pressing surface may be provided with a flange 46b having a piston hollow part 46a the central portion of which is open, and a porous filter 42′ having a number of pores may be adhered to and seated on the lower surface of the flange 46b.

A piston engaging shoulder 48 supposed to be seated and supported at an end of the cylinder 10 may be formed at an end of the piston block 44 of the compressive spray part 40, while extending from an end of the piston block 44. The pressure supplied by the piston block 44 with respect to the coffee grains (G) can be maintained constant by the piston engaging shoulder 48 of the piston block 44 seated and supported at the end of the cylinder 10.

An engaging protrusion 16 may be preferably formed at an outer side of the top of the cylinder 10 which forms the water accommodation part 14. If the nozzle (N) of the water supply part is large, the outer side of the cylinder 10 may be inserted and engaged with respect to the inner side of the nozzle (N). At this time, the engaging protrusion 16 may be inserted and seated in the concave groove formed at the inner side of the nozzle (N).

The engaging protrusion 16 may be formed of screw threads. The inner side of the nozzle (N) may be formed of screw threads which may match therewith.

### INDUSTRIAL APPLICABILITY

According to the present invention, the extraction time of the Dutch coffee can be reduced by a predetermined time, and the natural flavor of the coffee can be enhanced with respect to the same mount and time through the uniform extraction of the coffee extract with respect to all the coffee grains. Moreover, the density between the coffee grains can be variable based on the user's preference. The densely compressed coffee grains can always have the same density even when the user carries, which makes it possible to maintain a constant flavor, and the user can easily carry it with him.

1. A Dutch coffee capsule, comprising:
a cylindrical cylinder configured to accommodate coffee grains;
a coffee extraction part which is engaged to an end of the cylinder and is configured to discharge a coffee extract; and
a compressive spray part which is provided with a plurality of small holes and a piston block which contacts close to the inner wall of the cylinder and is configured to supply a compressive force to the coffee grains, thus allowing an even water permeation.

2. The capsule of claim 1, wherein the coffee extraction part comprises:
an engaging finishing part which is engaged to an end of the cylinder;
a filter which is seated on the upper side of the engaging finishing part and is able to prevent the discharge of the coffee grains; and
a filter seating part which fixedly contacts close to the lower end of the inner side of the cylinder so as to fixedly seat the filter with respect to the engaging finishing part.

3. The capsule of claim 2, wherein the filter seating part comprises:
a first outer circumferential surface having an outer diameter corresponding to the inner diameter of the cylinder;
a second outer circumferential surface having an outer diameter corresponding to the outer diameter of the cylinder and configured to be seated at an end of the cylinder; and
a rib which is provided at an inner, lower side so as to provide a seating force to the filter.

4. The capsule of claim 3, wherein in terms of the engagement between the coffee extraction part and the cylinder, the engaging finishing part is engaged with respect to an end of the cylinder in a state where the shoulder of the second outer circumferential surface of the filter seating part has been seated at an end of the cylinder, and then the filter has positioned at the lower surface of the rib of the filter seating part.

5. The capsule of claim 1, wherein the outer side of the piston block has a friction coefficient with respect to the inner side of the cylinder so as to prevent the degradation of the compressive density of the compressed coffee grains.

6. The capsule of claim 1, wherein the size of each small hole of the compressive spray part is large enough to allow the water to slowly and evenly permeate into the coffee grain accommodation part while withstanding the gravity with the aid of the surface tension of the water falling down into the water accommodation part of the upper surface of the piston block.

7. The capsule of claim 6, further comprising a water inlet part which is engaged to the other end of the cylinder and is configured to allow the inflow of water, and the water inlet part is formed of an engaging block which is engaged to the other end of the cylinder and has an opening part in the center thereof, and a sealing sheet configured to seal the opening part.

8. The capsule of claim 1, wherein an engaging finishing part is formed integral with the cylinder, and in a state where the filter has been seated on the upper surface of the inner side of the engaging finishing part formed integral with the cylinder, the filter seating part is inserted into the inner side of the cylinder, and the filter is fixedly seated.

9. The capsule of claim 5, wherein the engaging finishing part is formed integral with the cylinder, and in a state where the filter has been seated on the upper surface of the inner side of the engaging finishing part formed integral with the cylinder, the filter seating part is inserted into the inner side of the cylinder, and the filter is fixedly seated.

10. The capsule of claim 9, wherein the filter is seated at the inner side of the engaging finishing part, and the compressive spray part includes a piston block which has a flange formed of a piston hollow part the central portion of which is open and is configured to slide inward of the cylinder; and a porous filter which is engaged to the lower surface of the flange.

11. The capsule of claim 10, wherein a piston engaging shoulder is formed at an end of the piston block, while extending from the end of the piston block, so as to be seated and supported at an end of the cylinder.

12. The capsule of claim 11, further comprising an engaging protrusion formed at the upper portion of outer side the cylinder.

13. The capsule of claim 8, wherein the filter seating part is not provided in the Dutch coffee capsule.

14. The capsule of claim 2, wherein the outer side of the piston block has a friction coefficient with respect to the inner side of the cylinder so as to prevent the degradation of the compressive density of the compressed coffee grains.

15. The capsule of claim 3, wherein the outer side of the piston block has a friction coefficient with respect to the inner side of the cylinder so as to prevent the degradation of the compressive density of the compressed coffee grains.

16. The capsule of claim 4, wherein the outer side of the piston block has a friction coefficient with respect to the inner side of the cylinder so as to prevent the degradation of the compressive density of the compressed coffee grains.

17. The capsule of claim 2, wherein the size of each small hole of the compressive spray part is large enough to allow the water to slowly and evenly permeate into the coffee grain accommodation part while withstanding the gravity with the aid of the surface tension of the water falling down into the water accommodation part of the upper surface of the piston block.

18. The capsule of claim 3, wherein the size of each small hole of the compressive spray part is large enough to allow the water to slowly and evenly permeate into the coffee grain accommodation part while withstanding the gravity with the aid of the surface tension of the water falling down into the water accommodation part of the upper surface of the piston block.

19. The capsule of claim 4, wherein the size of each small hole of the compressive spray part is large enough to allow the water to slowly and evenly permeate into the coffee grain accommodation part while withstanding the gravity with the aid of the surface tension of the water falling down into the water accommodation part of the upper surface of the piston block.

20. The capsule of claim 2, wherein an engaging finishing part is formed integral with the cylinder, and in a state where the filter has been seated on the upper surface of the inner side of the engaging finishing part formed integral with the cylinder, the filter seating part is inserted into the inner side of the cylinder, and the filter is fixedly seated.

21. The capsule of claim 3, wherein an engaging finishing part is formed integral with the cylinder, and in a state where the filter has been seated on the upper surface of the inner side of the engaging finishing part formed integral with the cylinder, the filter seating part is inserted into the inner side of the cylinder, and the filter is fixedly seated.

22. The capsule of claim 4, wherein an engaging finishing part is formed integral with the cylinder, and in a state where the filter has been seated on the upper surface of the inner side of the engaging finishing part formed integral with the cylinder, the filter seating part is inserted into the inner side of the cylinder, and the filter is fixedly seated.
